(19) United States
(12) Patent Application Publication
(10) Pub. No.: US 2022/0373076 A1
(43) Pub. Date: Nov. 24, 2022

(54) TRANSMISSION AND CONTROL METHOD FOR LUBRICATING OIL PRESSURE CONTROL VALVE

(71) Applicants: JATCO Ltd, Fuji-shi, Shizuoka (JP); Nissan Motor Co., Ltd., (US)

(72) Inventors: Akira NISHIMURA, Kawasaki-shi, Kanagawa (JP); Arata NAKAMURA, Ebina-shi, Kanagawa (JP); Yuki TAWARA, Shizuoka-shi, Shizuoka (JP); Katsuhiro MATSUO, Isehara-shi, Kanagawa (JP)

(73) Assignees: JATCO Ltd, Fuji-shi, Shizuoka (JP); Nissan Motor Co., Ltd., Kanagawa-ku, Yokohama-shi (JP)

(21) Appl. No.: 17/782,907

(22) PCT Filed: Nov. 6, 2020
(86) PCT No.: PCT/JP2020/041502

§ 371 Date: Jun. 6, 2022

(30) Foreign Application Priority Data
Dec. 6, 2019 (JP) 2019-221648

(51) Int. Cl. F16H 57/04

(52) U.S. Cl. CPC F16H 57/0435; F16H 57/0436; F16H 57/0415

(57) ABSTRACT

A transmission, includes a transmission mechanism configured to shift a rotary power input from a power source; an oil pump configured to discharge an oil to be supplied to the transmission mechanism; a lubricating oil pressure control valve configured to adjust a pressure of the oil discharged from the oil pump and supply the oil to a lubrication target portion of the transmission mechanism; and a cooler configured to cool the oil to be supplied to the lubrication target portion of the transmission mechanism by outside air. The lubricating oil pressure control valve adjusts the pressure of the oil supplied to the lubrication target portion in a manner that the pressure of the oil supplied to the lubrication target portion increases as an outside air temperature decreases.

### TECHNICAL FIELD

The present invention relates to lubrication of a transmission.

### BACKGROUND ART

JP2009-216155A discloses a transmission including an oil cooler that cools an oil to be supplied to a lubrication target portion of a transmission.

### SUMMARY OF INVENTION

However, in such a transmission, the oil is cooled by the oil cooler in an environment where the outside air temperature is low, increasing the viscosity of the oil and causing more pressure loss of the oil. As a result, the oil may fail to reach the end of the lubrication target portion sufficiently, and the lubrication may be insufficient at the lubrication target portion.

The present invention has been made in view of such a technical problem, and the purpose of the present invention is to enable proper lubrication of a lubrication target portion even if the outside air temperature changes in a transmission including a cooler that cools the oil to be supplied to the lubrication target portion of the transmission mechanism.

According to an aspect of the present invention, a transmission, including: a transmission mechanism configured to shift a rotary power input from a power source; an oil pump configured to discharge an oil to be supplied to the transmission mechanism; a lubricating oil pressure control valve configured to adjust a pressure of the oil discharged from the oil pump and supply the oil to a lubrication target portion of the transmission mechanism; and a cooler configured to cool the oil to be supplied to the lubrication target portion of the transmission mechanism by outside air, is provided. The lubricating oil pressure control valve adjusts the pressure of the oil supplied to the lubrication target portion in a manner that the pressure of the oil supplied to the lubrication target portion increases as an outside air temperature decreases.

According to the aforementioned aspect, the lubricating oil pressure control valve operates in a manner that the oil pressure of the oil supplied to the lubrication target portion increases as the outside air temperature decreases. In other words, the oil pressure is adjusted based on the increase of the viscosity of the oil due to the decrease of the outside air temperature to supply the oil to the lubrication target portion of the transmission mechanism. Therefore, even if the oil is cooled due to the decrease of the outside air temperature, it is possible to appropriately lubricate the portions requiring lubrication in the transmission mechanism.

### BRIEF DESCRIPTION OF DRAWINGS

FIG. 1 is a schematic configuration diagram of a hydraulic circuit of a transmission according to an embodiment of the present invention.

FIG. 2 is a map for setting a lubricating oil pressure.

FIG. 3 is a flowchart showing the processing contents of a lubricating oil pressure control by a controller.

FIG. 4 is a diagram showing the changes according to the outside air temperature in the lubricating oil pressure set at a specific turbine rotation speed, a specific turbine torque, and a specific oil pan oil temperature.

### DESCRIPTION OF EMBODIMENTS

Embodiments of the present invention will be described below with reference to the accompanying drawings.

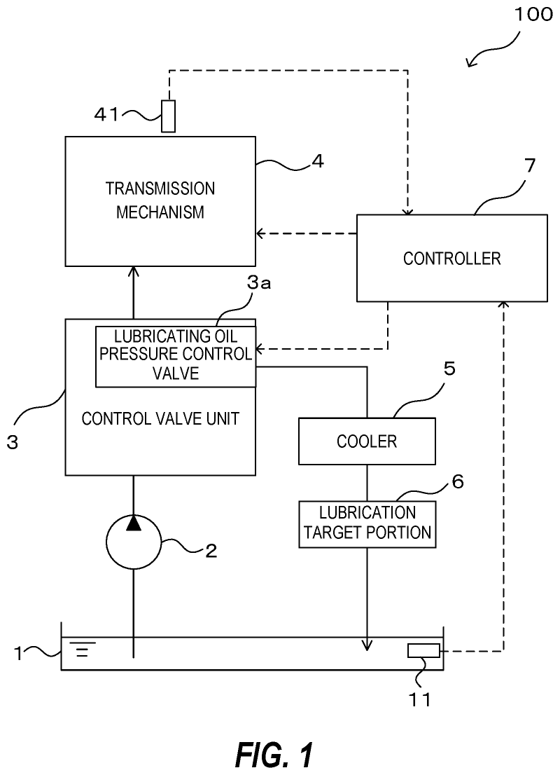

FIG. 1 is a diagram showing a configuration of a hydraulic circuit of a transmission 100 according to an embodiment of the present invention. The transmission 100 includes an oil pan 1, an oil pump 2, a control valve unit 3 having a lubricating oil pressure control valve 3a, a transmission mechanism 4, a cooler 5, a lubrication target portion 6, and a controller 7.

The oil pan 1 stores a predetermined amount of oil for the supply to the transmission mechanism 4, the lubrication target portion 6, etc. In addition, the oil supplied to the transmission 100 is discharged from the transmission mechanism 4, the lubrication target portion 6, etc. to be described later, and is recovered in the oil pan 1. The oil pan 1 is provided with an oil pan oil temperature sensor 11 that detects the temperature of the oil stored in the oil pan 1 (oil pan oil temperature To).

The oil pump 2 pumps up the oil stored in the oil pan 1, generates an oil pressure to discharge the oil, and supplies the oil to the control valve unit 3. The oil pump 2 may be a mechanical oil pump driven by power input from a power source, or may be an electric oil pump driven by a supply of electric power.

The control valve unit 3 adjusts the pressure of the oil supplied from the oil pump 2 by an unillustrated control valve, and supplies the oil to the transmission mechanism 4. Further, the control valve unit 3 adjusts the pressure of the oil supplied from the oil pump 2 by the lubricating oil pressure control valve 3a, and supplies the oil to the lubrication target portion 6 to be described later. Further, the lubricating oil pressure control valve 3a is configured of a lubrication valve and a solenoid that controls the lubrication valve.

The transmission mechanism 4 includes a torque converter and a gear position mechanism (not illustrated). The gear position mechanism changes an engagement state of frictional engagement elements according to the oil pressure of the oil supplied from the control valve unit 3 to achieve a predetermined gear position. When rotary power is input from an engine (not illustrated) which acts as the power source, the torque converter amplifies the torque according to the rotation speed difference between the input side and the output side, and transmits the rotary power to the gear position mechanism. The gear position mechanism shifts the transmitted rotary power at a transmission ratio corresponding to the gear position. The turbine of the torque converter is provided with a turbine rotation speed sensor 41 that detects a turbine rotation speed Nt.

The cooler 5 is provided between the lubricating oil pressure control valve 3a and the lubrication target portion 6 in the hydraulic circuit. The cooler 5 cools the oil whose pressure is adjusted by the lubricating oil pressure control valve 3a and supplies the oil to the lubrication target portion 6. In this embodiment, the cooler 5 is an air-cooled heat exchanger. When the oil supplied to the cooler 5 passes through a plurality of thin tubes constituting the heat exchanger, the oil is cooled by the outside air that comes into contact with the outer walls of the thin tubes.

The lubrication target portion 6 is a comprehensive representation of the portions of the transmission mechanism 4 that are lubricated by oil, such as the rotating unit, sliding unit, and bearing unit. In FIG. 1, the lubrication target portion 6 is drawn outside the transmission mechanism 4 for convenience, but the lubrication target portion 6 is a part of the transmission mechanism 4. The lubrication target portion 6 is lubricated by the oil supplied from the cooler 5. Further, the oil which has lubricated the lubrication target portion 6 is then discharged to the oil pan 1.

The controller 7 is a control device that controls the transmission 100, and is configured of one or a plurality of microcomputers including a central processing unit (CPU), a storage device (RAM and ROM) and an input/output interface (I/O interface). Detection signals are input to the controller 7 from a vehicle speed sensor or an accelerator pedal opening sensor provided in the vehicle mounted with the transmission 100. The controller 7 determines the gear position that the gear position mechanism should take based on these signals. Then, the controller 7 controls the control valve unit 3 to adjust the pressure of the oil supplied to the transmission mechanism 4 in order to realize the gear position.

Further, the detection signals of the oil pan oil temperature To and the turbine rotation speed Nt are input to the controller 7 from each of the oil pan oil temperature sensor 11 and the turbine rotation speed sensor 41. The controller 7 controls the oil pressure of the oil supplied from the lubricating oil pressure control valve 3a to the lubrication target portion 6 (hereinafter referred to as “lubricating oil pressure”) to ensure the required oil pressure for supplying oil to the end of the lubrication target portion 6, that is, the lower limit of the oil pressure at which the lubrication target portion 6 does not cause poor lubrication (hereinafter referred to as “required lubricating oil pressure”), based on the oil pan oil temperature To, the turbine rotation speed Nt, and the turbine torque Tt calculated from the engine torque and the torque ratio of the torque converter.

By the way, when the transmission 100 is placed in an environment where the outside air temperature is low, the oil is cooled by the cooler 5, the viscosity of the oil increases, and the pressure loss when supplying the oil to the lubrication target portion 6 increases. As a result, the oil may fail to reach the end of the lubrication target portion 6 sufficiently, and the lubrication may be insufficient at the lubrication target portion 6.

Therefore, in this embodiment, the controller 7 controls the lubricating oil pressure by considering the outside air temperature in addition to the oil pan oil temperature To, the turbine rotation speed Nt, and the turbine torque Tt.

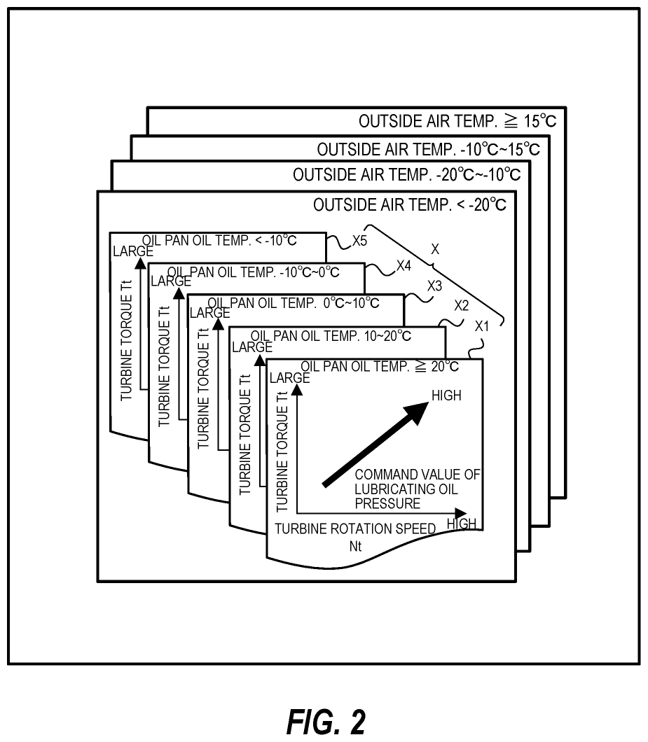

The control of the lubricating oil pressure executed by the controller 7 is described with reference to FIGS. 2-4.

As shown in FIG. 2, the storage device of the controller 7 has stored a plurality of maps for calculating the command value of lubricating oil pressure (maps X1˜Xn, hereinafter collectively referred to as “map X”) based on the outside air temperature, oil pan oil temperature To, turbine rotation speed Nt and turbine torque Tt.

To reduce the amount of data, regarding the outside air temperature and oil pan temperature, the map X has been prepared for each predetermined outside air temperature range (lower than −20° C., equal to or higher than −20° C. and lower than −10° C., equal to or higher than −10° C. and lower than 15° C., higher than 15° C.) and for each predetermined oil pan temperature range (lower than −10° C., equal to or higher than −10° C. and lower than 0° C., equal to or higher than 0° C. and lower than 10° C., equal to or higher than 10° C. and lower than 20° C., higher than 20° C.). The controller 7 selects and refers to the map corresponding to the outside air temperature, oil pan oil temperature To, turbine rotation speed Nt and turbine torque Tt, and calculates the command value of lubricating oil pressure.

The required lubricating oil pressure tends to increase as the outside air temperature decreases or as the oil pan oil temperature To decreases. Therefore, for each map X, the required lubricating oil pressure, which corresponds to the lowest value in the corresponding outside air temperature range (the minimum expected outside air temperature in the range where there is no lower limit) as well as the lowest value in the corresponding oil pan temperature range (the minimum expected oil pan temperature in the range where there is no lower limit), is stored as the command value of lubricating oil pressure. This ensures that the lubricating oil pressure achieved based on the command value does not fall below the required lubricating oil pressure.

For example, in the map X1 where the outside air temperature is lower than −20° C. and the oil temperature To is equal to or higher than 20° C., the required lubricating oil pressure, which corresponds to the minimum expected outside air temperature of −40° C. and oil pan temperature of 20° C., is stored as the command value of lubricating oil pressure.

Further, since the required lubricating oil pressure tends to increase as the turbine rotation speed Nt increases or as the turbine torque Tt increases, the command value of lubricating oil pressure stored in each map X also has the same tendency.

In this way, the controller 7 sets the command value of lubricating oil pressure in consideration of the outside air temperature in addition to the turbine rotation speed Nt, the turbine torque Tt, and the oil pan oil temperature To. That is, the controller 7 sets the command value of lubricating oil pressure based on the change of oil temperature and oil viscosity in the cooler 5 due to the change of outside air temperature.

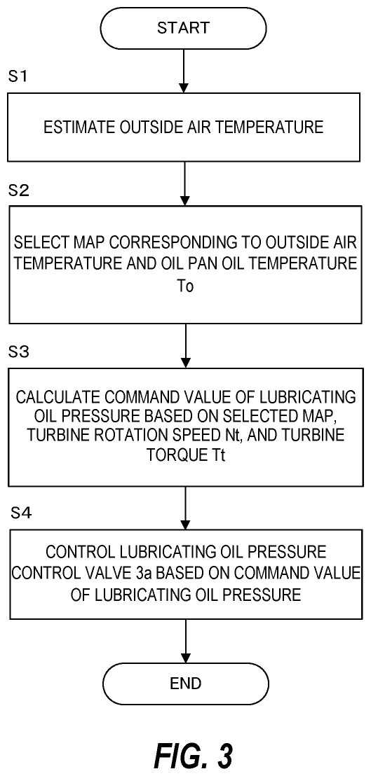

Next, the specific processing contents of the lubricating oil pressure control by the controller 7 will be described with reference to FIG. 3.

First, in Step S1, the controller 7 acquires the intake air temperature Te of the engine, which is obtained from the detection signal of the intake air temperature sensor of the engine, from the engine controller, and estimates the outside air temperature based on the intake air temperature Te of the engine. There is a correlation that the outside air temperature decreases as the intake air temperature Te of the engine decreases, and thus, the controller 7 estimates that the outside air temperature decreases as the intake air temperature Te of the engine decreases. Once the controller 7 estimates the outside air temperature, the controller 7 advances the process to Step S2.

In Step S2, from a plurality of maps X, the controller 7 selects the map corresponding to the outside air temperature estimated in Step S1 and the oil pan oil temperature To calculated based on the signal input from the oil pan oil temperature sensor 11, and advances the process to Step S3.

In Step S3, the controller 7 calculates the command value of lubricating oil pressure based on the map X selected in Step S2, the turbine rotation speed Nt calculated from the signal input from the turbine rotation speed sensor 41, and the turbine torque Tt calculated from the engine torque and the torque ratio of the torque converter. After calculating the command value of lubricating oil pressure, the controller 7 advances the process to Step S4.

In Step S4, the controller 7 controls the lubricating oil pressure control valve 3a so that the lubricating oil pressure becomes the command value based on the command value of lubricating oil pressure calculated in Step S3. Thereby, the lubricating oil pressure is controlled to be equal to or higher than the required lubricating oil pressure.

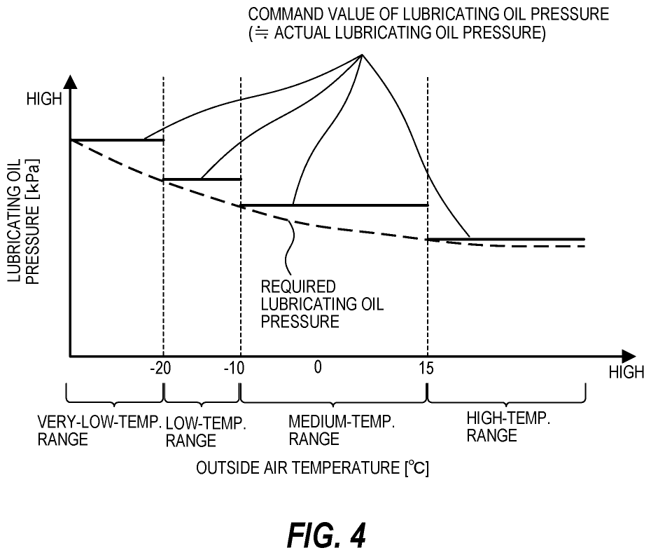

FIG. 4 is a diagram showing how the lubricating oil pressure, which is set at a specific turbine rotation speed Nt, a specific turbine torque Tt, and a specific oil pan oil temperature To, changes according to the outside air temperature. The solid line shows the command value of lubricating oil pressure, and the actual lubricating oil pressure controlled based on the command value is almost equal to the command value of lubricating oil pressure. The dashed line shows the required lubricating oil pressure.

As shown in FIG. 4, the lubricating oil pressure tends to increase as the outside air temperature decreases. Since the map X is prepared for each predetermined outside air temperature range, the lubricating oil pressure changes stepwise according to the outside air temperature, but in each outside air temperature range, the required lubricating oil pressure, which corresponds to the lowest value in the corresponding outside air temperature range (the minimum expected outside air temperature in the range where there is no lower limit), is set as the command value of lubricating oil pressure, and thus, the lubricating oil pressure is always set higher than the required lubricating oil pressure.

Thereby, even in a situation where the outside air temperature is low and the viscosity of the oil is high, the oil can be supplied to the end of the lubrication target portion 6 and the lubrication target portion 6 can be appropriately lubricated.

Further, here the lubricating oil pressure changes stepwise according to the outside air temperature due to the influence of the number of maps X prepared, but it is not necessary to change the lubricating oil pressure stepwise, and the number of maps X may be increased, or the command value of lubricating oil pressure may be set using a function, and the lubricating oil pressure may be changed smoothly according to the outside air temperature.

Subsequently, the actions and effects of the embodiments described so far will be described.

(1) In this embodiment, the transmission 100 includes: the transmission mechanism 4 that shifts the rotary power input from the engine; the oil pump 2 that discharges the oil to be supplied to the transmission mechanism 4; the lubricating oil pressure control valve 3a that adjusts the pressure of the oil discharged from the oil pump 2 and supplies the oil to the lubrication target portion 6 of the transmission mechanism 4; and the cooler 5 that cools the oil to be supplied to the lubrication target portion 6 of the transmission mechanism 4 by the outside air. The lubricating oil pressure control valve 3a adjusts the pressure of the oil supplied to the lubrication target portion 6 in a manner that the lubricating oil pressure supplied to the lubrication target portion 6 increases as the outside air temperature decreases.

According to this configuration, the lubricating oil pressure control valve 3a adjusts the oil pressure based on the increase of the viscosity of the oil, which is caused by the oil being cooled through the cooler 5 due to the decrease of the outside air temperature. Therefore, even if the oil temperature decreases in the cooler 5 due to the decrease of the outside air temperature, the oil is supplied to the lubrication target portion 6 at an oil pressure suitable for the oil temperature, and thus, the lubrication target portion 6 can be appropriately lubricated.

(2) Further, the outside air temperature is calculated based on the intake air temperature Te of the engine.

According to this configuration, the lubricating oil pressure can be controlled based on the influence of the outside air temperature without newly providing a sensor for detecting the outside air temperature in the transmission 100 itself.

(3) In the above configuration, the outside air temperature is calculated based on the intake air temperature Te of the engine, but the method of obtaining the outside air temperature is not limited to this, for example, the outside air temperature may be detected by an outside air temperature sensor which detects the outside air temperature and is attached to a front bumper, a door mirror, etc.

According to this configuration, the lubricating oil pressure is controlled based on the measured outside air temperature, and thus, rather than controlling the lubricating oil pressure based on the estimated outside air temperature, it is possible to supply the oil to the lubrication target portion 6 with a more appropriate oil pressure to lubricate the lubrication target portion 6 appropriately.

(4) The outside air temperature may be acquired from the weather information obtained via wireless communication (mobile phone line, radio, etc.).

With this configuration, the lubricating oil pressure can be controlled according to the outside air temperature, and the lubrication target portion 6 can be appropriately lubricated.

While the embodiments of the present invention have been described above, the above description of the embodiments is merely one example of application of the invention, and is not intended to limit the technical scope of the invention to the specific configuration of the above embodiments.

The present application claims a priority of Japanese Patent Application No. 2019-221648 filed with the Japan Patent Office on Dec. 6, 2019, all the contents of which are hereby incorporated by reference.

1. A transmission, comprising:
a transmission mechanism configured to shift a rotary power input from a power source;
an oil pump configured to discharge an oil to be supplied to the transmission mechanism;
a lubricating oil pressure control valve configured to adjust a pressure of the oil discharged from the oil pump and supply the oil to a lubrication target portion of the transmission mechanism; and
a cooler configured to cool the oil to be supplied to the lubrication target portion of the transmission mechanism by outside air,
wherein the lubricating oil pressure control valve adjusts the pressure of the oil supplied to the lubrication target portion in a manner that the pressure of the oil supplied to the lubrication target portion increases as an outside air temperature decreases.

2. The transmission according to claim 1, wherein
the outside air temperature is calculated based on an intake air temperature of the power source.

3. The transmission according to claim 1, wherein
the outside air temperature is detected by an outside air temperature sensor for detecting the outside air temperature.

4. The transmission according to claim 1, wherein
the outside air temperature is acquired from weather information obtained from an outside.

5. A control method for a lubricating oil pressure control valve in a transmission including:
a transmission mechanism that shifts a rotary power input from a power source;
an oil pump that discharges an oil to be supplied to the transmission mechanism;
a lubricating oil pressure control valve that adjusts a pressure of the oil discharged from the oil pump and supplies the oil to a lubrication target portion of the transmission mechanism; and
a cooler that cools the oil to be supplied to the lubrication target portion of the transmission mechanism by outside air, the method comprising:
controlling the lubricating oil pressure control valve to adjust the pressure of the oil supplied to the lubrication target portion in a manner that the pressure of the oil supplied to the lubrication target portion increases as an outside air temperature decreases.
